(19) United States
(12) Patent Application Publication
(10) Pub. No.: US 2025/0202701 A1
(43) Pub. Date: Jun. 19, 2025

(54) METHOD AND APPARATUS WITH HOMOMORPHIC ENCRYPTION OPERATION

(71) Applicants: Samsung Electronics Co., Ltd., Suwon-si (KR); Seoul National University R&DB Foundation, Seoul (KR)

(72) Inventors: Jung Ho AHN, Seoul (KR); Jongmin KIM, Seoul (KR); Sangpyo KIM, Seoul (KR)

(73) Assignees: Samsung Electronics Co., Ltd., Suwon-si (KR); Seoul National University R&DB Foundation, Seoul (KR)

(21) Appl. No.: 18/980,357

(22) Filed: Dec. 13, 2024

(30) Foreign Application Priority Data
Dec. 14, 2023 (KR) 10-2023-0182186
Mar. 26, 2024 (KR) 10-2024-0041092

(51) Int. Cl. H04L 9/30; G06F 17/14; H04L 9/00

(52) U.S. Cl. CPC H04L 9/3093; G06F 17/144; H04L 9/008

(57) ABSTRACT

A method with a number-theoretic transform (NTT) operation includes allocating an element of a matrix to a data lane such that elements in a first column of the matrix corresponding to a polynomial are allocated to the data lane of a first lane group among lane groups, wherein the matrix is a square matrix, and a number of elements comprised in the matrix is N, performing a first NTT operation on a data lane of a fourth root of the N for each of the lane groups, allocating a result of the first NTT operation to the data lane such that the matrix is transposed, based on adjustment of a reading order of a buffer that stores the result of the first NTT operation, and performing a second NTT operation on the data lane of the fourth root of the N for each of the lane groups.

### CROSS-REFERENCE TO RELATED APPLICATIONS

This application claims the benefit under 35 USC § 119 (a) of Korean Patent Application No. 10-2023-0182186, filed on Dec. 14, 2023, and Korean Patent Application No. 10-2024-0041092, filed on Mar. 26, 2024, in the Korean Intellectual Property Office, the entire disclosures of which are incorporated herein by reference for all purposes.

### BACKGROUND

### 1. Field

The following description relates to a method and apparatus with a homomorphic encryption (HE) operation.

### 2. Description of Related Art

Discrete Fourier transform (DFT) is a mathematical theory that may be used in mathematical and engineering applications, such as signal processing, cryptography, and scientific operations, and has various variants, such as number-theoretic transform (NTT) and the like. NTT may be used to quickly perform a polynomial multiplication operation that is used in a homomorphic encryption (HE) operation.

HE is a encryption method that enables arbitrary operations between pieces of encrypted data. The use of HE enables arbitrary operations on encrypted data without decrypting the encrypted data, and HE is lattice-based and is thus resistant to quantum algorithms and safe. However, in a lattice-based encryption system, in which multiplication between high-degree polynomials occurs frequently, a method of processing NTT may be inefficient, as the method may not quickly multiply between polynomials, and an operator or an accelerator, which processes NTT, may likewise be inefficient.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a method with a number-theoretic transform (NTT) operation includes allocating an element of a matrix to a data lane such that elements in a first column of the matrix corresponding to a polynomial are allocated to the data lane of a first lane group among lane groups, wherein the matrix is a square matrix, and a number of elements comprised in the matrix is N, performing a first NTT operation on a data lane of a fourth root of the N for each of the lane groups, allocating a result of the first NTT operation to the data lane such that the matrix is transposed, based on adjustment of a reading order of a buffer that stores the result of the first NTT operation, and performing a second NTT operation on the data lane of the fourth root of the N for each of the lane groups.

The matrix may be a matrix having a size of \sqrt{N}×\sqrt{N} in which N coefficients of the polynomial are stored in a row-majored order.

The matrix may correspond to a four-dimensional (4D) matrix comprising a submatrix having a size of 4\sqrt{N}×4\sqrt{N} as an element.

An element of a submatrix having a size of 4\sqrt{N}×4\sqrt{N}comprised in the matrix may be allocated to one type of the data lane.

Each of the lane groups may include 4\sqrt{N}data lanes, and an element comprised in the first column may be allocated to 4\sqrt{N}data lanes of the first lane group in one cycle of an NTT operation.

An element comprised in 4\sqrt{N}consecutive columns of the matrix may be allocated to one type of a lane group.

The first NTT operation and the second NTT operation may include a butterfly operation on columns of the matrix, a twisting operation, a transpose operation of the matrix, and a butterfly operation on rows of the matrix.

The first NTT operation and the second NTT operation may include either one or both of a discrete Fourier transform (DFT) operation and a fast Fourier transform (FFT) operation.

The twisting operation may be performed based on a twiddle factor corresponding to a geometric sequence of a predetermined common ratio.

A number of the lane groups may be determined to be at least one and less than or equal to a fourth root of the N.

The method may include storing a result of the second NTT operation in a register file (RF).

In one or more general aspects, a non-transitory computer-readable storage medium may store instructions that, when executed by one or more processors, configure the one or more processors to perform any one, any combination, or all of operations and/or methods disclosed herein.

In one or more general aspects, a number-theoretic transform (NTT) operator electronic device includes a data lane to which an element of a matrix corresponding to a polynomial is allocated, wherein the matrix is a square matrix, and a number of elements comprised in the matrix is N, a submodule for an NTT operation corresponding to a lane group comprising a data lane of a fourth root of the N, and a transposing and twisting module corresponding to the submodule, wherein the submodule may include a first NTT unit (NTTU) configured to perform a first NTT operation on the data lane of the fourth root of the N and a second NTTU configured to perform a second NTT operation on the data lane of the fourth root of the N.

The transposing and twisting module further may include a buffer configured to store an operation result of the first NTTU.

The electronic device may include a register configured to store an operation result of the second NTTU.

The submodule further may include a twiddle factor feeder configured to provide a twiddle factor used in a butterfly operation of the submodule.

The first NTT operation and the second NTT operation may include a butterfly operation on columns of the matrix, a twisting operation, a transpose operation of the matrix, and a butterfly operation on rows of the matrix.

The first NTT operation and the second NTT operation may include either one or both of a discrete Fourier transform (DFT) operation and a fast Fourier transform (FFT) operation.

The lane group may include 4\sqrt{N}data lanes, and an element comprised in a first column of the matrix may be allocated to 4\sqrt{N}data lanes of a first lane group in one cycle of an NTT operation.

An element comprised in 4\sqrt{N}consecutive columns of the matrix may be allocated to one type of a lane group.

Other features and aspects will be apparent from the following detailed description, the drawings, and the claims.

### BRIEF DESCRIPTION OF THE DRAWINGS

FIG. 1 illustrates an example of a homomorphic encryption (HE) system.

FIGS. 2A to 2C illustrate examples of a structure of a number-theoretic transform (NTT) operator for a fully homomorphic encryption (FHE) operation.

FIG. 3 illustrates an example of a structure of an NTT operator for an FHE operation.

FIG. 4 illustrates an example of a configuration of an NTT unit (NTTU) of a submodule.

FIG. 5A illustrates an example of an NTT operation method.

FIG. 5B illustrates an example of an algorithm of an NTT operation.

FIG. 6 illustrates an example of a configuration of an NTT operator.

FIG. 7 illustrates an example of a structure of an NTTU of an NTT operator.

FIG. 8 illustrates an example of a structure of an NTT operator including a variable number of submodules.

FIG. 9 illustrates an example of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

In connection with the description of the drawings, like reference numerals may be used for similar or related components. It is to be understood that a singular form of a noun corresponding to an item may include one or more of the things, unless the relevant context clearly indicates otherwise.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the state.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, the examples will be described in detail with reference to the accompanying drawings. When describing the examples with reference to the accompanying drawings, like reference numerals refer to like elements and a repeated description related thereto will be omitted.

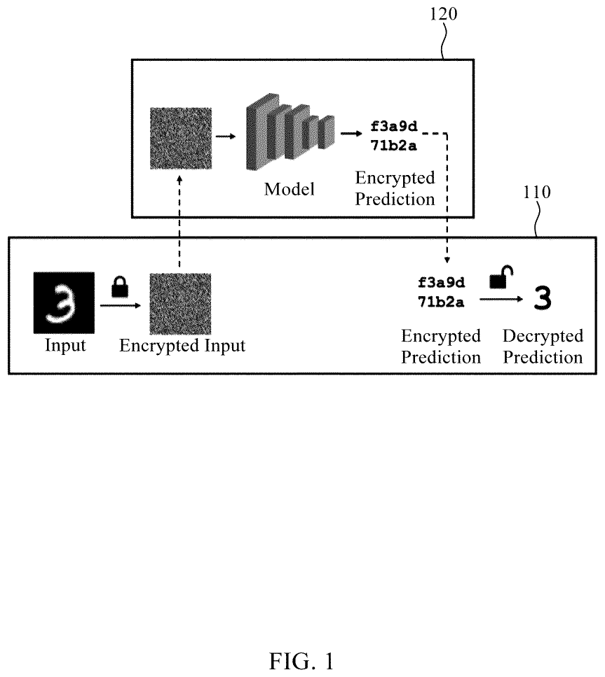

FIG. 1 illustrates an example of a homomorphic encryption (HE) system.

In a lattice-based encryption system in which multiplication between high-degree polynomials occurs frequently, a method and apparatus of one or more embodiments may quickly perform multiplication between polynomials. Referring to FIG. 1, the HE system may include a client 110 and a server 120 as agents.

The HE system may be a system in which the server 120 provides an artificial intelligence (AI) service to the client 110 without directly exposing data of the client 110 to the server 120.

The client 110 may be an agent receiving the AI service from the server 120 and may be referred to as a service-using entity, a service user, a data user, and the like. The client 110 may encrypt its own data (e.g., an image) through a client terminal based on an HE technique and may transmit the encrypted data to the server 120. The client terminal may be referred to as a user terminal.

HE is an encryption technique for performing an operation on encrypted data without decryption. When various operations are performed on homomorphically encrypted data, the results are identical to those of the same operations performed on unencrypted data. HE may process data while the data is encrypted, offering a solution to privacy concerns in the data industry.

The server 120 may receive the encrypted data from the client 110 and may transmit an AI operation result corresponding to the encrypted data to the client 110. The server 120 may be referred to as a service provider, a service-providing entity, and the like.

The server 120 may provide various AI services to the client 110. For example, the server 120 may provide the client 110 with a service such as face recognition or mask detection, where maintaining the confidentiality of user data is crucial. However, a typical operation used for providing an AI service requires a large amount of memory and extensive network data transmission. For example, when typically encrypting data for convolutional neural network inference, numerous homomorphic ciphertexts are generated, demanding a large amount of memory and extensive network data transmission.

An HE operation may support an addition operation, a multiplication operation, and a rotation operation, which rearranges the order within the same encryption, and the execution time increases in the order of addition, multiplication, and rotation.

HE may have a predetermined degree of a polynomial as a parameter. This degree may need to be a power of 2. As the degree of a polynomial increases, the execution time of all operations exponentially increases. However, a higher degree of a polynomial enables a wider variety of operations and improves the accuracy of calculations.

An HE operation may allow a predetermined maximum number of HE multiplications. As this maximum number of multiplications increases, the time required for a single HE operation may increase exponentially. Furthermore, this maximum number of multiplications may be limited by a degree of a polynomial. As the degree increases, the maximum number of multiplications also may increase.

In Cheon-Kim-Kim-Song (CKKS), a user may pack complex numbers or n real numbers into a vector message m. The vector message m may be converted into an integer polynomial Pₘ of an n-1 dimension (n≤N/2) and may be referred to as a plaintext. The integer polynomial Pₘ may be encrypted to a ciphertext [[m]] using a polynomial Aₘ of any large coefficient, a secret polynomial S, and an error polynomial E of a small coefficient. Ring-learning-with-errors (RLWE) may guarantee the difficulty of extracting the integer polynomial Pₘ, that is, the vector message m, when RLWE only knows the ciphertext [[m]], which is a polynomial pair in a cyclotomic polynomial ring R_{Q} having the ciphertext [[m]], that is, an extremely large integer coefficient (e.g., 21,200). For example, the vector message m and the ciphertext [[m]] may be defined as Equation 1 below.

$$m = ( {m}_{0} , {m}_{1} , … , {m}_{n - 1} ) ∈ {ℂ}^{n} \\ ⌊ Δ \cdot m ⌉ ↦ {P}_{m} = {a}_{0} + {a}_{1} X + … + {a}_{N - 1} {X}^{N - 1} \\ [ [ m ] ] = ( {B}_{m} , {A}_{m} ) = ( {A}_{m} * S + {P}_{m} + E , {A}_{m} ) ∈ {ℛ}_{Q}^{2} \qquad Equation 1$$

The ciphertext [[m]] may be transmitted to a server for offload computation on the vector message m. For example, when f (m) computation is offloaded, the server may perform homomorphic evaluation of f on the ciphertext [[m]]. The homomorphic evaluation may include various primitive HE operations on the ciphertext [[m]]. The primitive HE operations may include addition HAdd or multiplication HMult between the ciphertext [[m]] and other ciphertexts, addition PAdd or multiplication PMult between the ciphertext [[m]] and a plaintext, addition CAdd or multiplication CMult between the ciphertext [[m]] and a constant, a cyclic rotation HRot operation on the ciphertext [[m]], or the like. The primitive HE operations may be combined to form more complex HE operations.

The primitive HE operations may be subdivided into a major (a polynomial) function including NTT, base conversion BConv, automorphism, and other element-wise functions (addition, multiplication, subtraction, etc.).

To efficiently process a large integer, a method and apparatus of one or more embodiments may use a residue number system (RNS). In a cyclotomic polynomial ring R_{Q}, all integer operations may be modulo operations on a polynomial modulus Q. The polynomial modulus Q may be set to a product of RNS prime numbers q₀, . . . , q_{L-1}, which are small enough to fit into a machine word, and a coefficient of each polynomial may be decomposed as shown in Equation 2 below, for example. An expensive large integer operation may be replaced with a set of M parallel modulo-qᵢ operations.

$$RNS : a ↦ ( a mod {q}_{0} , a mod {q}_{1} , … , a mod {q}_{L - 1} ) \qquad Equation 2$$

RNS may convert a polynomial of a degree N-1 into an L×N matrix, and in the L×N matrix, each row may be referred to as a ‘limb’ of the polynomial, and each row may correspond to a unique prime number qᵢ. Each limb may be considered as a separate polynomial in R_{qi}.

Polynomial multiplication in a cyclotomic polynomial ring R_{Q} may correspond to a convolution (e.g., a negacyclic convolution) between coefficients of two vectors and may have complexity of O (N²) when the polynomial multiplication is computed in a simple way. NTT is an integer version of the Fourier transform that may be applied to each vector and may reduce the overall complexity O (NlogN) by converting a convolution into simple element-wise multiplication and applying a fast Fourier transform (FFT) algorithm to the convolution. Inverse NTT (INTT) must be performed to obtain the final result, but the polynomial may be generally maintained in aversion to which an NTT operation is applied, that is, evaluation representation (or operation representation or representation of the operation result), and more element-wise functions may be computed in the evaluation representation. However, some functions may require performing INTT to restore the polynomial to its original form, referred to as coefficient representation. When (I) NTT is used with the RNS, (I) NTT may be applied to each limb of the L×N matrix. (I) NTT may include NTT and/or INTT.

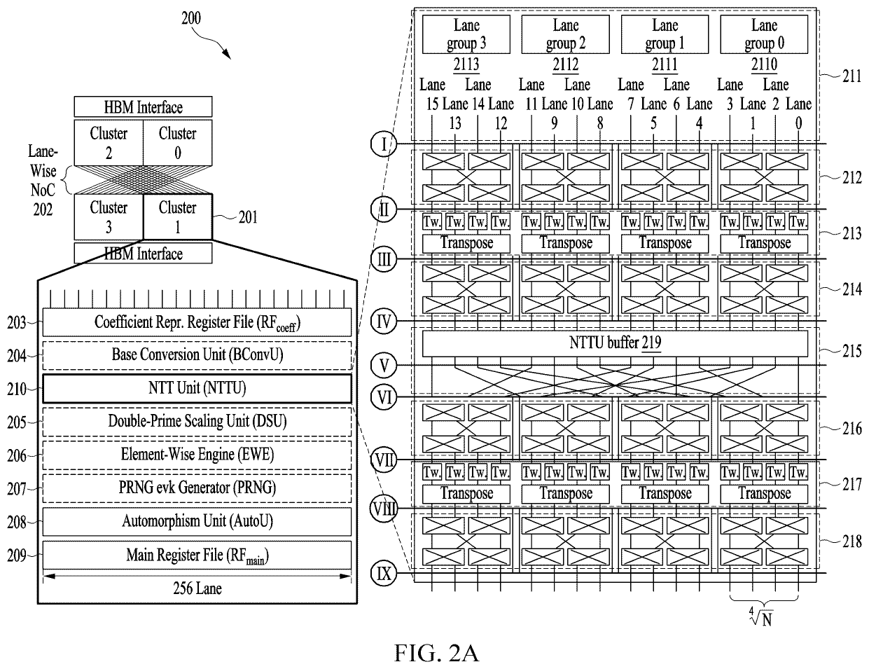

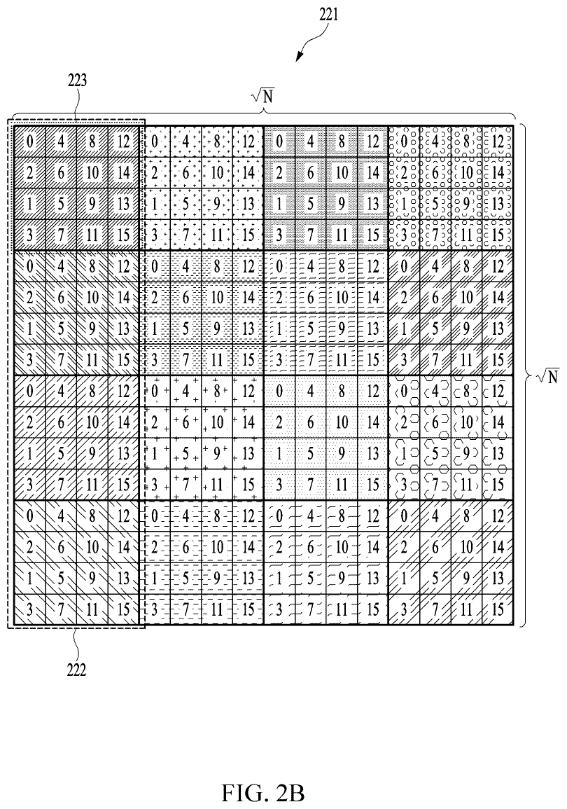

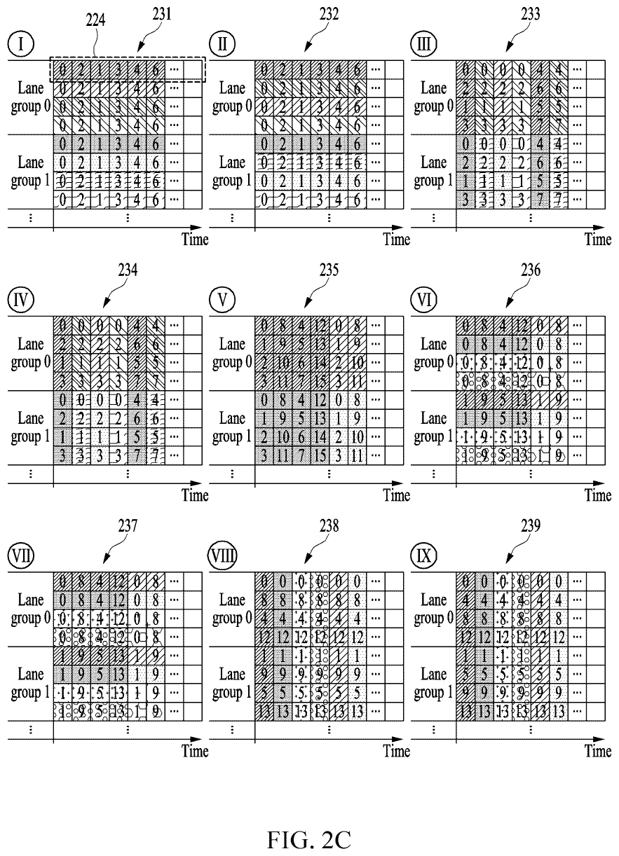

FIG. 2A illustrates an example of a structure of an NTT operator (e.g., one or more processors) for a fully homomorphic encryption (FHE) operation.

A short-word hierarchical accelerator for robust and practical fully homomorphic encryption (SHARP) 200 may correspond to an FHE CKKS accelerator and/or an NTT operator. The SHARP 200 may be an operator aimed at reducing an area and power consumption for practical execution of an FHE workload.

The SHARP 200 may correspond to an NTT operator based on a vector architecture. The SHARP 200 may include clusters 201 having \sqrt{N}data lanes and a lane-wise network-on-chip (NoC) 202, and the same global data distribution policy may be applied to the clusters 201.

Each of the clusters 201 may be divided into M=4\sqrt{N}lane groups, and each lane group may include M adjacent data lanes. By changing a data organization method in each of the clusters 201, the long-distance data exchange may be replaced with a close data exchange between the adjacent data lanes in the lane group. (I) NTT may account for a significant portion of computations in FHE and may have a complex data exchange pattern that is difficult to process in the vector architecture. Accordingly, the quality of an HE accelerator may be determined depending on the method in which the vector architecture processes (I) NTT.

The SHARP 200 may include an NTT unit (NTTU) 210 (e.g., an NTT module (NTTM)) for an (I) NTT operation. In addition, the SHARP 200 may further include an element-wise engine (EWE) 206 for FHE, a double-prime scaling unit (DSU) 205 (e.g., a double-prime scaling module (DSM)), a base conversion unit (BConvU) 204 (e.g., a base conversion module (BConvM)), an automorphism unit (AutoU) 208 (e.g., an automorphism module (AutoM)), and a pseudo-random number generator (PRNG) evk generator 207.

An input limb of the NTTU 210 may be a M²× M² matrix. As described above, M may be ⁴ \sqrt{N} (i.e., M=⁴\sqrt{N}). For example, when M is 256, (i.e., M=256), the input limb of the NTTU 210 may be a matrix 221 shown in FIG. 2B. The NTTU 210 may include a set 211 of 16 data lanes grouped into 4 lane groups. Referring to I to IV steps 212, 213, and 214, a primary NTT phase (phase 1) of the four steps may be performed on a first M²-point. The NTT phases of the four steps may include a butterfly operation on columns of an input matrix, a twisting operation, a transpose operation, and a butterfly operation on rows of the input matrix.

Each lane group may receive one column of a matrix for M cycles from a coefficient Representation register file (RF) (RF_{coeff}) 203 and may perform the NTT phases on the received one column. For example, in step I, referring to a graph 231 of FIG. 2C illustrating data allocated to each data lane, when M is 4 (i.e., M=4), elements 222 in the four columns shown in FIG. 2B may be allocated to lane group 0 2110, and elements in the next four columns may be allocated to lane group 1 2111. A 4×4 submatrix in the four columns may be allocated to each of the data lanes in the lane group 0 2110. For example, elements of a first submatrix 223 shown in FIG. 2B may be allocated to a first data lane 224 shown in FIG. 2C in order of column priority for each cycle.

Referring to FIG. 2C, as shown in a graph 232 of a result of performing the butterfly operation on the columns in phase 1, data allocated to each data lane may be changed. As shown in a graph 233 of a result of performing the twisting operation and transpose operation on the columns in phase 1, data allocated to each data lane may be changed. As shown in a graph 234 of a result of performing the butterfly operation on the rows in phase 1, data allocated to each data lane may be changed.

When the NTT phases of the four steps are performed on each lane group, a long semi-global connection between the data lanes of different lane groups may be unnecessary. An intra-lane-group transpose module may convert M-strided access that is across the lane group into non-strided access for columns. The conversation result obtained by the intra-lane-group transpose module may be stored in an NTTU buffer 219, and the order in which data stored in the NTTU buffer 219 is read may be changed in response to the result of performing the NTT phases on all columns of the matrix arriving. Based on the adjustment of the reading order of the NTTU buffer 219, data allocated to each data lane may be changed, as shown in a graph 235.

Referring to steps IV to VI 215 and 216, the transpose between the lane groups may be performed through a wire connection of all clusters 201. As a result of performing the transpose between the lane groups, data allocated to each data lane may be changed, as shown in a graph 236. Then, referring to steps VI to IX 216, 217, and 218, a secondary NTT phase (phase 2) of the four steps may be performed.

Referring to FIG. 2C, as shown in a graph 237 of a result of performing the butterfly operation on the columns in phase 2, data allocated to each data lane may be changed. As shown in a graph 238 of a result of performing the twisting operation and the transpose operation on the columns in phase 2, data allocated to each data lane may be changed. As shown in a graph 239 of a result of performing the butterfly operation on the rows in phase 2, data allocated to each data lane may be changed.

Each lane group may perform an M²-point NTT operation on one row of the matrix and may store the result in a main RF (RFₘₐᵢₙ) 209. INTT may be performed in the reverse order.

Hereinafter, an on-the-fly twist (OF-Twist) application method in the NTTU 210 is described. For example, when M is 4 (i.e., M=4), in phase 1, the sequence of M² twiddle factors (or twisting factors) of the data lane may be formed as follows:

Phase1(M=4):1,ζ,ζ²,ζ³,1,ζ,ζ²,ζ³,1,ζ,ζ²,ζ³,1,ζ,ζ²,ζ³,1,ζ,ζ²,ζ³

The sequence of the twiddle factors corresponding to phase 1 may be divided into M geometric sequences of the same common ratio 2, so OF-Twist may be easily applied.

OF-Twist may be used in phase 2 by accessing an M rows allocated to the lane group in the bit-reversed row access order. For example, referring to the graph 236 illustrating the data allocated to each data lane in step VI when M is 4 (i.e., M=4), rows 0, 4, 8, and 12 may be allocated to the lane group 0 2110. By accessing a row in order of rows 0, 8, 4, and 12, the sequence of the twiddle factors may be formed as follows:

Phase2(M=4):1,ζ,ζ²,ζ³,1,ζ,ζ³,ζ⁶,ζ⁹,1,ζ,ζ⁵,ζ¹⁰,ζ¹⁵,1,ζ⁷,ζ¹⁴,ζ²¹

This sequence may be divided into M geometric sequences of common ratios ζ, ζ³, ζ⁵,and ζ⁷. A unique double OF-Twist module may be used to support this pattern. The unique double OF-Twist module may generate the entire sequence in real time by receiving the first common ratio ζ and a common ratio ζ² of common ratios.

In addition, in phase 2, the twiddle factors of a butterfly module may be changed every M cycle. The twiddle factors may be formed as geometric sequences through the bit-reversed row access. An OF-Twiddle module (or a single OF-Twiddle module), which is similar to the OF-Twist module, may be disposed in the butterfly module in phase 2.

The bit-reversed row access order may be used as the default data order in the RF main 209 to simplify data access. This may be based on the observation that all limbs do not affect key features other than (I) NTT and automorphism as long as all limbs follow the same data order. Hereinafter, the sequential access of the RFₘₐᵢₙ 209 may represent accessing data in the bit-reversed row access order.

The NTTU 210 may be expanded to the cluster configuration having a large number of data lanes and may reduce the horizontal bisection bandwidth of the NTTU 210 and the length of wiring for a horizontal connection.

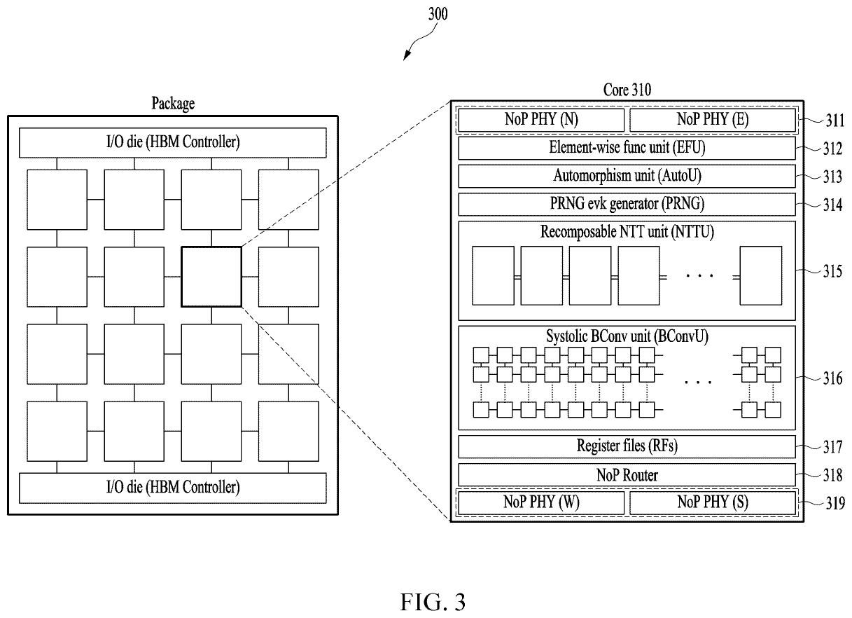

FIG. 3 illustrates an example of a structure of an NTT operator for an FHE operation.

Referring to FIG. 3, a chiplet-based FHE accelerator with a resizable structure (CiFHER) 300 is a multi-chip module (MCM) architecture for FHE acceleration proposed to reduce the high cost of monolithic chip configuration and may correspond to a tiled architecture including a plurality of chiplet cores connected by a mesh network-on-package (NoP).

A core 310 of the CiFHER 300 may be configured to have various computational throughputs that may be adjusted according to a package configuration. For example, the CiFHER 300 may correspond to the SHARP 200.

The core 310 may include a recomposable NTTU 315, a systolic BConvU 316, an AutoU 313, an element-wise function unit (EFU) 312 (e.g., an element-wise function module (EFM)), a pseudo-random number generator (PRNG) evk generator 314, an NoP router 318 and NoP physical layers (PHYs) 311 and 319 for NoP communication, and RFs 317. For example, the recomposable NTTU 315 may correspond to the NTTU 210 of the SHARP 200. For example, the RFs 317 may correspond to the RF coeff 203 and the RFₘₐᵢₙ 209 of the SHARP 200. For example, the configurations of the core 310, including the recomposable NTTU 315 and the RFs 317, may correspond to the configurations of the SHARP 200.

The core 310 may adopt a vector architecture, and a plurality of parallel data lanes may be disposed in the core 310. Each data lane has a dedicated RF space that other data lanes may not access so that the parallelism may be maximized with low synchronization and arbitration costs. The vector architecture may be effective in reducing the communication overhead and RF bandwidth pressure, which are major bottlenecks in FHE.

The recomposable NTTU 315 is a recomposable module and may adjust the number of data lanes. For example, the recomposable NTTU 315 may support various configurations having data lanes in a predetermined range (e.g., 16 or more and 256 or less). The recomposable NTTU 315 may consider a polynomial having a length of N as a \sqrt{N}×\sqrt{N}matrix and may perform 2D-FFT based (I) NTT on a ⁴ \sqrt{N}-point along rows and then columns. 2D-FFT-based (I) NTT may correspond to the NTT phases of the four steps described above. Four steps of a 2D-FFT dataflow may be applied to each (I) NTT in the row direction and the column direction. For example, when N is 28 (i.e., N=28), the recomposable NTTU 315 may include a compact NTTU that encompasses or processes \sqrt{N}=16 lanes, and the compact NTTU may be referred to as a submodule of the recomposable NTTU 315.

Up to 16 submodules may be stacked and may provide a higher computational throughput for (I) NTT. By performing a shuffle between submodules, (I) NTT may be performed on a limb by combining the submodules. The shuffle may convert data scattered across various submodules into an order in which the data may effectively be transposed using quadrant swap modules.

The quadrant swap is an operation for the transpose of a matrix and may include an operation of dividing a square matrix into four quadrants and swapping elements in the second and fourth quadrants. For example, in the case of a K×K quadrant swap for any number K, the K×K quadrant swap, a K/2×K/2 quadrant swap, . . . , a 2×2 quadrant swap may be performed sequentially.

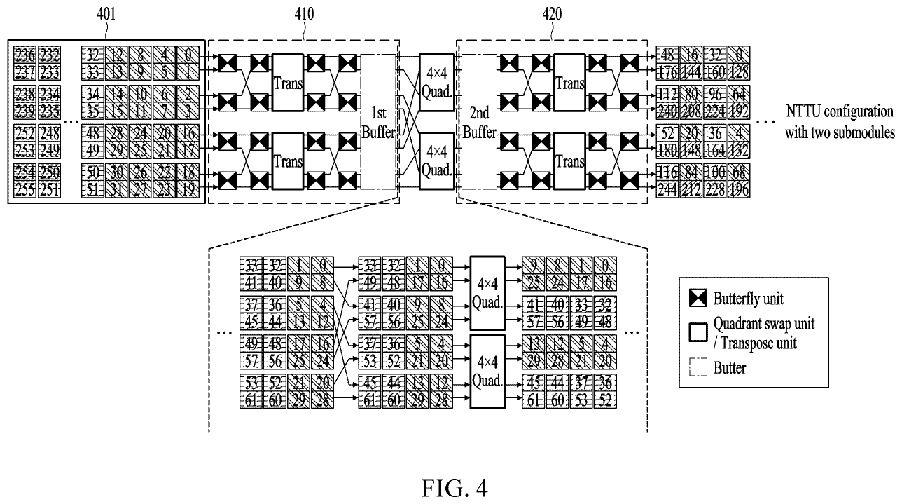

An example of an NTTU configuration of two submodules performing NTT in which N is 28 (i.e., N=28) is described below with reference to FIG. 4. Referring to FIG. 4, a polynomial having a length of 28, which is input data 401 of an NTTU, may be regarded as a 16×16 matrix. Some areas 410 of a submodule may perform the NTT phases of the four steps on rows (data index: 0-15/16-32). The execution of 16-point NTT on the rows may start with a stride-1 butterfly operation and may end with a stride-8 operation. Then, the intermediate buffering and shuffling stages may redistribute data between different submodules so that each submodule may retain a data element having stride-16 in a second buffer. That is, each submodule may retain elements of columns. Finally, some areas 420 of a submodule may perform the NTT phases of the four steps on columns (data index: 0-240/4-244 and stride-16). The execution of 16-point NTT on the columns may start with a stride-16 butterfly operation and may end with a stride-128 operation.

A recomposable NTTU may allow up to 4\sqrt{N}=16 cores to perform (I) NTT on an accompanying limb. In this case, the data exchange between cooperating cores may occur in response to the buffering and shuffling stages when NTT is performed.

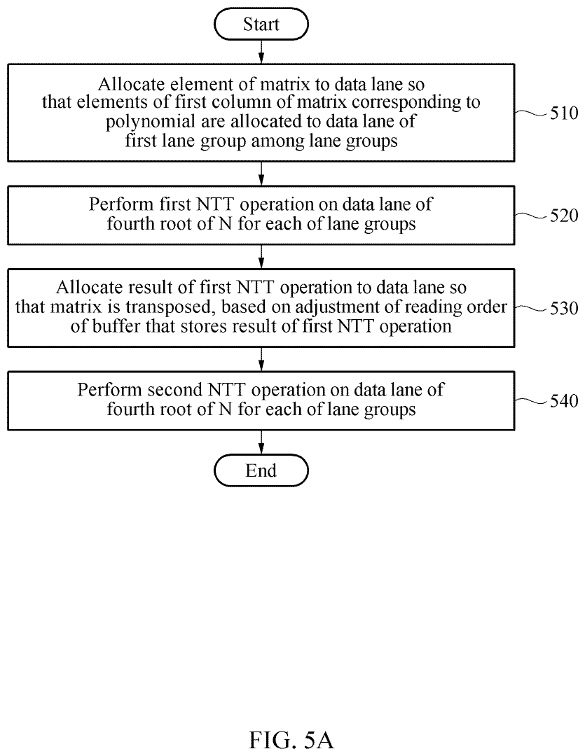

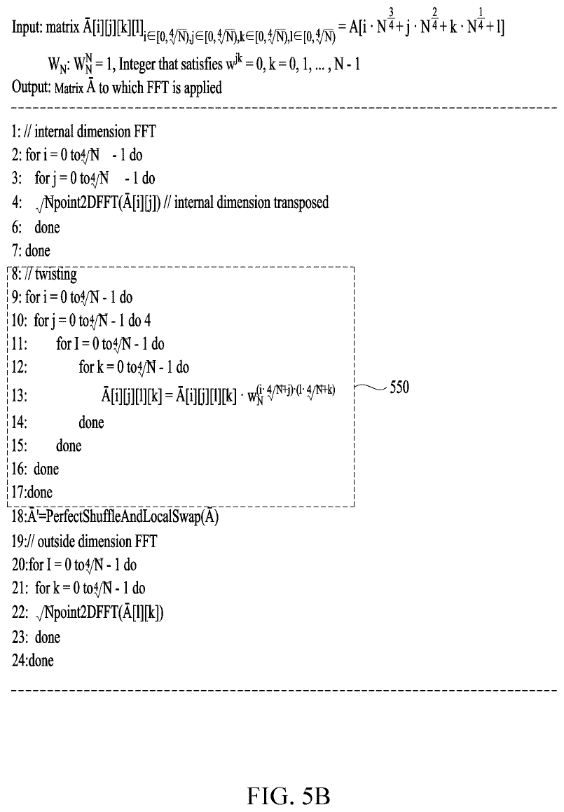

FIG. 5A illustrates an example of an NTT operation method.

Referring to FIG. 5A, an NTT operation method may include operation 510 of allocating an element of a matrix to a data lane so that elements of a first column of the matrix corresponding to a polynomial are allocated to the data lane of a first lane group among lane groups. The matrix may be a square matrix, and the number of elements included in the matrix may be N (N is any natural number).

The matrix may be a matrix having a size of \sqrt{N}×\sqrt{N} in which N coefficients of the polynomial are stored in the row-majored order. The polynomial may be a polynomial of a degree N-1, and N coefficients including coefficients of a constant term may be stored as elements of the matrix. For example, referring to FIG. 2B, when N is 256 (i.e., N=256), the matrix 221 may have a 16×16 size, and N coefficients of the polynomial may be stored in the matrix 221 in the row-majored order. That is, the matrix 221 may be expressed as a two-dimensional (2D) array A[i] [j] (iϵ[0, \sqrt{N}] and jϵ[0, \sqrt{N}]) and may be converted into a one-dimensional (1D) form of A [i] [j]=A [i·\sqrt{N}+j].

The matrix may correspond to a four-dimensional (4D) matrix including a submatrix having a size of \sqrt{N}×\sqrt{N} as an element. For example, referring to FIG. 2B, when N is 256 (i.e., N=256), the matrix 221 may correspond to a 4D matrix including a submatrix having a 4×4 size as an element. The matrix 221 may include 16 submatrices. Elements displayed with the same color in the matrix 221 may be elements corresponding to one type of a submatrix. For example, the first submatrix 223 may be a 4×4 matrix including 16 elements displayed in the same color. That is, the matrix 221 may be expressed as a 4D array A [i] [j] [k] [l] (iϵ[0, 4\sqrt{N}], jϵ[0, 4\sqrt{N}], jϵ[0, 4\sqrt{N}],and lϵ[0, 4\sqrt{N}])) and may be converted into a 1D form of

$$A [ i ] [ j ] [ k ] [ l ] = A [ i \cdot {N}^{\frac{3}{4}} + j \cdot {N}^{\frac{2}{4}} + k \cdot {N}^{\frac{1}{4}} + l ] .$$

The lane group may include a data lane of a fourth root 4\sqrt{N} of the N. The lane group may correspond to the lane group described above with reference to FIG. 2. The lane group may include 4\sqrt{N}adjacent data lanes. For example, when N is 256 (i.e., N=256), the lane group may include 4 data lanes. For example, referring to FIG. 2A, the lane group 0 2110 may include data lanes 0 to 3, the lane group 1 2111 may include data lanes 4 to 7, lane group 2 2112 may include data lanes 8 to 11, and lane group 3 2113 may include data lanes 12 to 15.

An element included in 4\sqrt{N}consecutive columns of the matrix may be allocated to one type of a lane group. For example, referring to FIGS. 2A and 2B, the elements 222 included in the four columns corresponding to j=0, 1, 2, and 3 in the matrix 221 (i.e., A [i] [j]) shown in FIG. 2B may be allocated to the lane group 0 2110.

In one cycle of an NTT operation, an element included in the same column of the matrix may be allocated to 4\sqrt{N}data lanes of one type of lane group. For example, referring to FIG. 2B, in the matrix 221 (i.e., A [i] [j]), the elements 222 included in the four columns corresponding to j=0, 1, 2, and 3 and four elements with the same numbers may correspond to elements to be allocated to the lane group 0 2110 in one cycle. For example, referring to the graph 231 corresponding to step I of FIG. 2C, an element included in the same column of the matrix may be allocated to each lane group for each cycle.

An element of a submatrix having a size of \sqrt{N}×\sqrt{N} included in the matrix may be allocated to one type of a data lane. For example, the first submatrix 223 shown in FIG. 2B may be allocated to one type of a data lane. For example, referring to the graph 231 corresponding to step I of FIG. 2C, elements included in the first submatrix 223 may be allocated to the first data lane 224 included in the lane group 0 2110. One element may be allocated per cycle, and the elements included in the first submatrix 223 may be allocated to the first data lane 224 over 16 cycles.

The NTT operation method may include operation 520 of performing a first NTT operation on the data lane of the fourth root 4\sqrt{N} of the N for each of the lane groups. The first NTT operation may correspond to the NTT phases of the four steps described above. That is, the first NTT operation may include a butterfly operation on columns of the matrix, a twisting operation, a transpose operation of the matrix, and a butterfly operation on rows of the matrix.

The twisting operation may correspond to OF-Twist described above. The twisting operation may be performed based on twiddle factors (or twisting factors) corresponding to a geometric sequence of a predetermined common ratio ζ e.g., ζ).

For example, corresponding to a matrix

$$A [ i ] [ j ] [ k ] [ l ] = A [ i \cdot {N}^{\frac{3}{4}} + j \cdot {N}^{\frac{2}{4}} + k \cdot {N}^{\frac{1}{4}} + l ] ,$$

the twisting operation may be performed based on a twisting algorithm 550 shown in FIG. 5B. FIG. 5B may correspond to pseudo code corresponding to an algorithm of a \sqrt{N}point 2D-FFT based NTT operation. The algorithm described with reference to FIG. 5B may correspond to the NTT phases of the four steps.

The NTT operation method may include operation 530 of allocating the result of the first NTT operation to the data lane so that the matrix is transposed, based on the adjustment of the reading order of a buffer that stores the result of the first NTT operation. The buffer that stores the result of the first NTT operation may correspond to the NTTU buffer 219 described above. For example, operation 530 may correspond to step III to the step IV 214 described above.

The NTT operation method may include operation 540 of performing a second NTT operation on the data lane of the fourth root 4\sqrt{N} of the N for each of the lane groups. The second NTT operation may correspond to the NTT phases of the four steps described above. That is, the second NTT operation may include a butterfly operation on columns of the matrix, a twisting operation, a transpose operation of the matrix, and a butterfly operation on rows of the matrix.

The twisting operation may correspond to OF-Twist described above. The twisting operation may be performed based on twiddle factors (or twisting factors) corresponding to a geometric sequence of a predetermined common ratio ζ e.g., ζ).

The NTT operation method may include storing the result of the second NTT operation in an RF. The RF in which the result of the second NTT operation is stored may correspond to the RFₘₐᵢₙ 209 described above.

The first NTT operation and the second NTT operation may include at least one of a discrete Fourier transform (DFT) operation or an FFT operation. When the difference between FFT and NTT is the difference between complex numbers and integers, the NTT operation method may be used for the FFT operation and/or DFT operation by changing the domain of some arithmetic logic units (ALUs) (e.g., changing a modular multiplicative ALU to a complex multiplicative ALU).

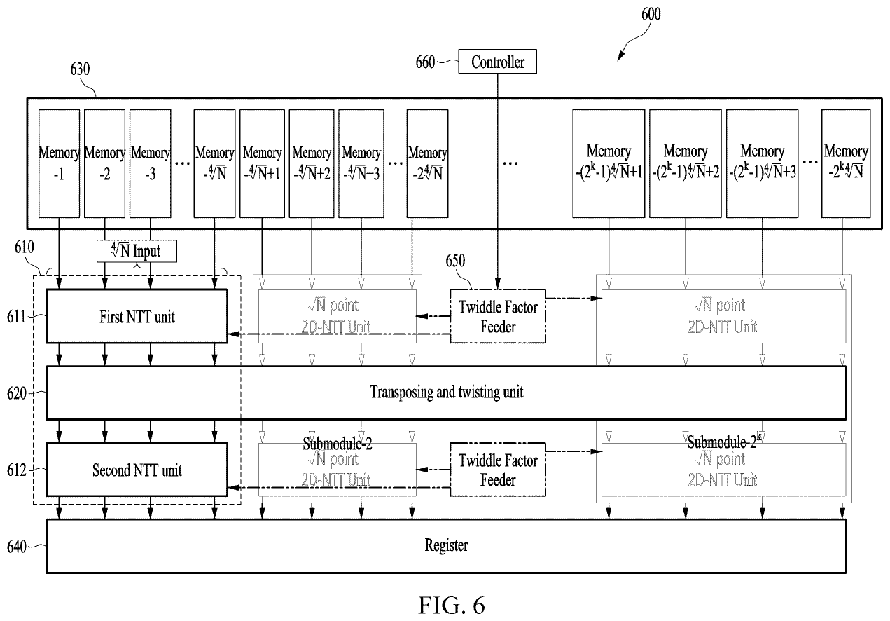

FIG. 6 illustrates an example of a configuration of an NTT operator.

Referring to FIG. 6, an NTT operator 600 may include a data lane to which an element of a matrix corresponding to a polynomial is allocated, a submodule 610 for an NTT operation corresponding to a lane group including a data lane of \sqrt{N} of N, and a transposing and twisting module 620 corresponding to the submodule 610.

Data stored in a first register 630 may be allocated to the data lane. For example, the first register 630 may include 2^{k}^{⁴} \sqrt{N} memory spaces (k is any natural number less than or equal to log₂⁴ \sqrt{N}). The NTT operator 600 may include 2^{k}^{⁴}⁴ \sqrt{N}data lanes. Data stored in the memory space of the first register 630 may be allocated to each data lane. For example, the first register 630 may correspond to the RF 203 described above.

\sqrt{N}data lanes may be grouped into one lane group. 2^{k} lane groups including 4\sqrt{N}data lanes may be generated. The NTT operator 600 may include 2^{k} submodules 610 corresponding to each of the 2^{k} lane groups.

The submodule 610 may include a first NTTU 611 that performs a first NTT operation on the 4\sqrt{N}data lanes and a second NTTU 612 that performs a second NTT operation on the VN data lanes. The first NTTU 611 and the second NTTU 612 may perform the NTT phases of the four steps described above. That is, the first NTTU 611 and the second NTTU 612 may be modules that perform a 2D-FFT operation or 2D-FFT-based NTT operation.

For example, the matrix corresponding to the polynomial is a 4D array A [i] [i] [k] [I] (iϵ[0, ⁴ \sqrt{N}], jϵ[0, \sqrt{N}], kϵ[0, \sqrt{N}], and lϵ[0, 4\sqrt{N}]), each submodule 610 may receive a i×k×1 matrix for different pieces of j and may first perform the 2D-FFT or 2D-FFT-based NTT operation on a matrix k×1. For example, the 2D-FFT-based NTT operation may be performed on the k×1 matrix by the first NTTU 611 of the submodule 610.

The performance result may be stored in a buffer of the transposing and twisting module 620. A j×k matrix having the same index (i, l) may be disposed in one row of the buffer. When the result of the first NTT operation on all k×1 matrices are stored in the buffer, the transpose of the matrix may be performed by extracting one row from the buffer and performing a perfect shuffle and local swap. Each submodule 610 before the transpose is performed by the transposing and twisting module 620 may perform the second NTT operation on the sequence in the k-dimension direction. In response to the transpose being performed, each submodule 610 may perform the second NTT operation on the sequence in the j-dimension direction. Here, when the order of selecting rows in the buffer is set in the i-dimension direction, a i×j matrix may be allocated to each submodule 610.

The NTT operator 600 may include a second register 640. The result of performing the second NTT operation may be stored in the second register 640. The second register 640 may correspond to the RFₘₐᵢₙ 209 described above.

The NTT operator 600 may include a twiddle factor feeder 650. The twiddle factor feeder 650 may provide twiddle factors required in a butterfly operation to the first NTTU 611 and the second NTTU 612. The twiddle factor feeder 650 may operate based on a signal from a controller 660. The controller 660 may provide a signal for determining the twiddle factors to the twiddle factor feeder 650. The OF-Twist operation described above may be performed based on the twiddle factors provided by the twiddle factor feeder 650.

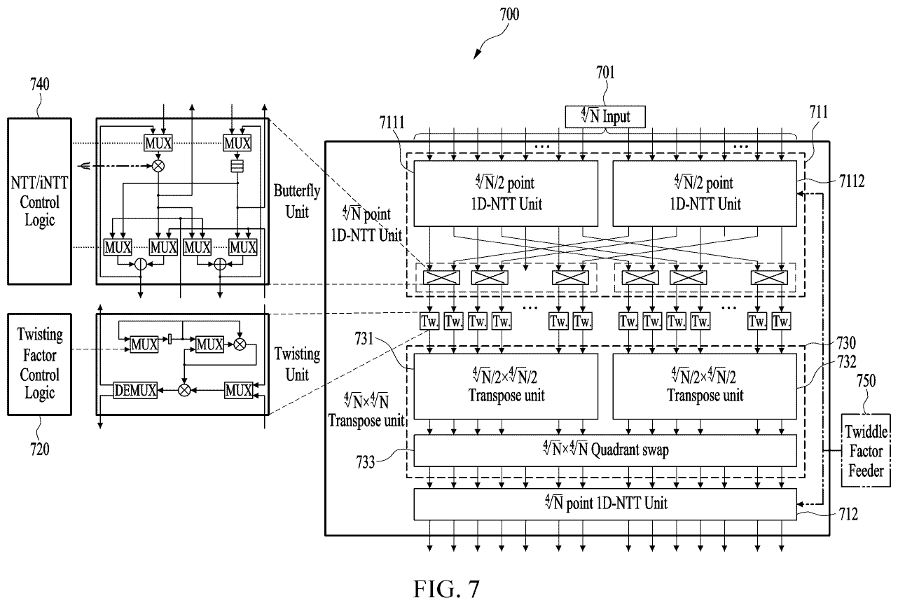

FIG. 7 illustrates an example of a structure of an NTTU of an NTT operator.

Referring to FIG. 7, an NTTU 700 may correspond to the first NTTU 611 or the second NTTU 612 included in the submodule 610 of the NTT operator 600 described above with reference to FIG. 6.

The NTTU 700 may perform the NTT phases of the four steps. The NTTU 700 may include a first ⁴ \sqrt{N}-point 1D-NTTU 711 and a second ⁴ \sqrt{N}-point 1D-NTTU 712, a twisting module 720, and a \sqrt{N}×\sqrt{N}transposing module 730 to perform the NTT phases of the four steps.

The NTTU 700 may include the first ⁴ \sqrt{N}-point 1D-NTTU 711 and the second ⁴ \sqrt{N}-point 1D-NTTU 712. The first ⁴ \sqrt{N}-point 1D-NTTU 711 may perform a butterfly operation on columns of a \sqrt{N} input 701. The second ⁴ \sqrt{N}-point 1D-NTTU 712 may perform a butterfly operation on rows of the 4\sqrt{N} input 701.

The first ⁴ \sqrt{N}-point 1D-NTTU 711 and the second ⁴ \sqrt{N}-point 1D-NTTU 712 may include four

$$\frac{\sqrt[4]{N}}{2}$$

point 1D-NTTUs 7111 and 7112 for a butterfly operation. The

$$\frac{\sqrt[4]{N}}{2}$$

point 1D-NTTUs 7111 and 7112 may include a butterfly module 740.

The twisting module 720 may perform a twisting operation based on the twiddle factors provided by the twiddle factor feeder 750.

The 4\sqrt{N}×4\sqrt{N}transposing module 730 may include two

$$\frac{\sqrt[4]{N}}{2} \times \frac{\sqrt[4]{N}}{2}$$

transposing modules 731 and 732 for the transpose of rows and columns of the 4\sqrt{N} input 701 and a ⁴\sqrt{N}×4\sqrt{N}quadrant swap module 733.

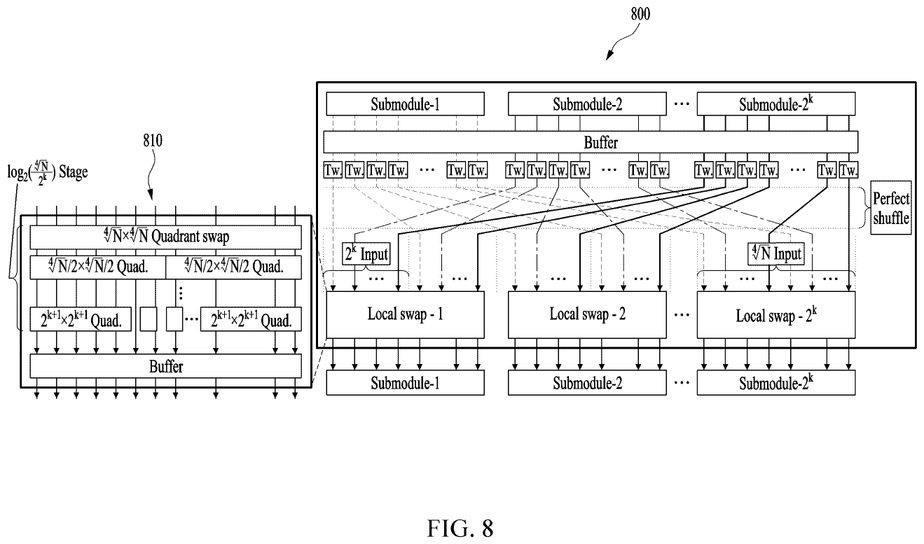

FIG. 8 illustrates an example of a structure of an NTT operator including a variable number of submodules.

An NTT operator 800 may be variably configured to include at least one submodule to a maximum of 4\sqrt{N}submodules. The number of submodules may correspond to the number of lane groups. That is, the number of lane groups may be determined to be at least one and less than or equal to a fourth root of N. The number of submodules may be determined to be the number of powers of 2 (i.e., 2^{k}) (k is any natural number) less than or equal to ⁴\sqrt{N}.

A structure of a transposing and twisting module may vary depending on the number of submodules. When the number of submodules is VN, the transposing and twisting module may be configured to perform the shuffle operation described above.

When the number of submodules is not VN, the transposing and twisting module may be configured to perform

$${log}_{2} \frac{\sqrt[4]{N}}{{2}^{k}}$$

local swap stages 810. The

$${log}_{2} \frac{\sqrt[4]{N}}{{2}^{k}}$$

local swap stages 810 may include a 4\sqrt{N}×4\sqrt{N} quadrant swap stage, a

$$\frac{\sqrt[4]{N}}{2} \times \frac{\sqrt[4]{N}}{2}$$

quadrant swap stage, . . . , 4\sqrt{N}/2^{2(k+1)} 2^{k+1}×2^{k+1} quadrant swap stage.

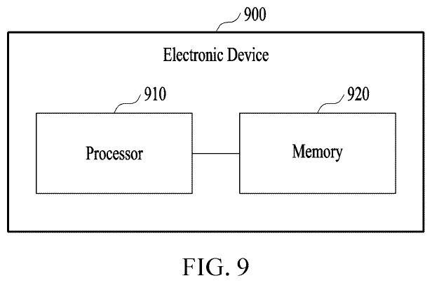

FIG. 9 illustrates an example of a configuration of an electronic device.

Referring to FIG. 9, an electronic device 900 may include a processor 910 (e.g., one or more processors) and a memory 920 (e.g., one or more memories). The memory 920 may be connected to the processor 910 and may store instructions executable by the processor 910, data to be operated by the processor 910, and/or data processed by the processor 910. The memory 920 may include a non-transitory computer readable medium, for example, a high-speed random-access memory (RAM), and/or a non-volatile computer readable storage medium (e.g., one or more disk storage devices, flash memory devices, and/or other non-volatile solid state memory devices). For example, the memory 920 may be or include a non-transitory computer-readable storage medium storing instructions that, when executed by the processor 910, configure the processor 910 to perform any one, any combination, or all of the operations and methods described herein with reference to FIGS. 1-8. The electronic device 900 may be implemented as at least one of a mobile device, such as a mobile phone, a smart phone, a personal digital assistant (PDA), a netbook, a tablet computer, and/or a laptop computer, a wearable device, such as a smart watch, a smart band, and/or smart glasses, a home appliance, such as a television (TV), a smart TV, and/or a refrigerator, a security device, such as a door lock, and/or a vehicle, such as an autonomous vehicle, and/or a smart vehicle.

The processor 910 may execute the instructions to perform the operations described with reference to FIGS. 1-8. The processor 910 may include any one or any combination of any two or more of the client 110, server 120, SHARP 200, clusters 201, NoC 202, RF_{coeff} 203, BConvU 204, DSU 205, EWE 206, PRNG evk generator 207, AutoU 208, RFₘₐᵢₙ 209, NTTU 210, set 211, lane groups 2110-2113, CiFHER 300, core 310, PHYs 311, EFU 312, AutoU 313, PRNG evk generator 314, recomposable NTTU 315, systolic BConvU 316, RFs 317, NoP router 318, PHYs 319, areas 410, areas 420, NTT operator 600, submodule 610, transposing and twisting module 620, first register 630, second register 640, twiddle factor feeder 650, controller 660, first NTTU 611, second NTTU 612, NTTU 700, twisting module 720, transposing module 730, butterfly module 740, twiddle factor feeder 750, first ⁴ \sqrt{N}-point 1D-NTTU 711,

$$\frac{\sqrt[4]{N}}{2}$$

point 1D-NTTUs 7111 and 7112,

$$\frac{\sqrt[4]{N}}{2} \times \frac{\sqrt[4]{N}}{2}$$

transposing modules 731 and 732, 4\sqrt{N}×4\sqrt{N}quadrant swap module 733, and 7112, second ⁴ \sqrt{N}-point 1D-NTTU 712 described herein with respect to FIGS. 1-8.

In addition, the descriptions provided with reference to FIGS. 1-8 may apply to the electronic device 900.

The clients, servers, SHARPs, clusters, NoCs, RF_{coeff}S, BConvUs, DSUs, EWEs, PRNG evk generators, AutoUs, RFₘₐᵢₙs, NTTUs, sets, lane groups, CiFHERs, cores, PHYs, EFUs, recomposable NTTUs, systolic BConvUs, RFs, NoP routers, areas, NTT operators, submodules, transposing and twisting modules, first registers, second registers, twiddle factor feeders, controllers, first NTTUs, second NTTUs, twisting modules, transposing modules, butterfly modules, twiddle factor feeders, first ⁴ \sqrt{N}-point 1D-NTTUs,

$$\frac{\sqrt[4]{N}}{2}$$

point 1D-NTTUs,

$$\frac{\sqrt[4]{N}}{2} \times \frac{\sqrt[4]{N}}{2}$$

transposing modules, 4\sqrt{N}×4\sqrt{N}quadrant swap modules, second ⁴ \sqrt{N}-point 1D-NTTUs, electronic devices, processors, NTTU buffers, memories, client 110, server 120, SHARP 200, clusters 201, NoC 202, RF_{coeff} 203, BConvU 204, DSU 205, EWE 206, PRNG evk generator 207, AutoU 208, RFₘₐᵢₙ 209, NTTU 210, set 211, NTTU buffer 219, lane groups 2110-2113, CiFHER 300, core 310, PHYs 311, EFU 312, AutoU 313, PRNG evk generator 314, recomposable NTTU 315, systolic BConvU 316, RFs 317, NoP router 318, PHYs 319, areas 410, areas 420, NTT operator 600, submodule 610, transposing and twisting module 620, first register 630, second register 640, twiddle factor feeder 650, controller 660, first NTTU 611, second NTTU 612, NTTU 700, twisting module 720, transposing module 730, butterfly module 740, twiddle factor feeder 750, first ⁴ \sqrt{N}-point 1D-NTTU 711,

$$\frac{\sqrt[4]{N}}{2}$$

point 1D-NTTUs 7111 and 7112,

$$\frac{\sqrt[4]{N}}{2} \times \frac{\sqrt[4]{N}}{2}$$

transposing modules 731 and 732, 4\sqrt{N}×4\sqrt{N}quadrant swap module 733, second ⁴ \sqrt{N}-point 1D-NTTU 712, NTT operator 800, electronic device 900, processor 910, and memory 920 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of anon-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD−ROMs, CD−Rs, CD+Rs, CD−RWs, CD+RWs, DVD−ROMs, DVD−Rs, DVD+Rs, DVD−RWs, DVD+RWs, DVD−RAMs, BD−ROMs, BD−Rs, BD−R LTHs, BD−REs, blue−ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method with a number-theoretic transform (NTT) operation, the method comprising:
allocating an element of a matrix to a data lane such that elements in a first column of the matrix corresponding to a polynomial are allocated to the data lane of a first lane group among lane groups, wherein the matrix is a square matrix, and a number of elements comprised in the matrix is N;
performing a first NTT operation on a data lane of a fourth root of the N for each of the lane groups;
allocating a result of the first NTT operation to the data lane such that the matrix is transposed, based on adjustment of a reading order of a buffer that stores the result of the first NTT operation; and
performing a second NTT operation on the data lane of the fourth root of the N for each of the lane groups.

2. The method of claim 1, wherein the matrix is a matrix having a size of \sqrt{N}×\sqrt{N} in which N coefficients of the polynomial are stored in a row-majored order.

3. The method of claim 1, wherein the matrix corresponds to a four-dimensional (4D) matrix comprising a submatrix having a size of 4\sqrt{N}×4\sqrt{N} as an element.

4. The method of claim 1, wherein an element of a submatrix having a size of 4\sqrt{N}×4\sqrt{N}comprised in the matrix is allocated to one type of the data lane.

5. The method of claim 1, wherein each of the lane groups comprises 4\sqrt{N}data lanes, and an element comprised in the first column is allocated to 4\sqrt{N}data lanes of the first lane group in one cycle of an NTT operation.

6. The method of claim 1, wherein an element comprised in 4\sqrt{N}consecutive columns of the matrix is allocated to one type of a lane group.

7. The method of claim 1, wherein the first NTT operation and the second NTT operation comprise:
a butterfly operation on columns of the matrix;
a twisting operation;
a transpose operation of the matrix; and
a butterfly operation on rows of the matrix.

8. The method of claim 1, wherein the first NTT operation and the second NTT operation comprise either one or both of a discrete Fourier transform (DFT) operation and a fast Fourier transform (FFT) operation.

9. The method of claim 7, wherein the twisting operation is performed based on a twiddle factor corresponding to a geometric sequence of a predetermined common ratio.

10. The method of claim 1, wherein a number of the lane groups is determined to be at least one and less than or equal to a fourth root of the N.

11. The method of claim 1, further comprising storing a result of the second NTT operation in a register file (RF).

12. A non-transitory computer-readable storage medium storing instructions that, when executed by one or more processors, configure the one or more processors to perform the method of claim 1.

13. A number-theoretic transform (NTT) operator electronic device comprising:
a data lane to which an element of a matrix corresponding to a polynomial is allocated, wherein the matrix is a square matrix, and a number of elements comprised in the matrix is N;
a submodule for an NTT operation corresponding to a lane group comprising a data lane of a fourth root of the N; and
a transposing and twisting module corresponding to the submodule,
wherein the submodule comprises a first NTT unit (NTTU) configured to perform a first NTT operation on the data lane of the fourth root of the N and a second NTTU configured to perform a second NTT operation on the data lane of the fourth root of the N.

14. The electronic device of claim 13, wherein the transposing and twisting module further comprises a buffer configured to store an operation result of the first NTTU.

15. The electronic device of claim 13, further comprising a register configured to store an operation result of the second NTTU.

16. The electronic device of claim 13, wherein the submodule further comprises a twiddle factor feeder configured to provide a twiddle factor used in a butterfly operation of the submodule.

17. The electronic device of claim 13, wherein the first NTT operation and the second NTT operation comprise:
a butterfly operation on columns of the matrix;
a twisting operation;
a transpose operation of the matrix; and
a butterfly operation on rows of the matrix.

18. The electronic device of claim 13, wherein the first NTT operation and the second NTT operation comprise either one or both of a discrete Fourier transform (DFT) operation and a fast Fourier transform (FFT) operation.

19. The electronic device of claim 13, wherein the lane group comprises 4\sqrt{N}data lanes, and an element comprised in a first column of the matrix is allocated to 4\sqrt{N}data lanes of a first lane group in one cycle of an NTT operation.

20. The electronic device of claim 13, wherein an element comprised in 4\sqrt{N}consecutive columns of the matrix is allocated to one type of a lane group.
